(19) United States
(12) Patent Application Publication
(10) Pub. No.: US 2004/0061092 A1
(43) Pub. Date: Apr. 1, 2004

(54) Wet etch for selective removal of alumina

(75) Inventors: Stanko R. Brankovic, Pittsburgh, PA (US); Billy W. Crue, Pittsburgh, PA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Seagate Technology LLC, Scotts Valley, CA

(21) Appl. No.: 10/654,093

(22) Filed: Sep. 3, 2003

Related U.S. Application Data
(60) Provisional application No. 60/414,726, filed on Sep. 30, 2002.

(51) Int. Cl. C09K 13/00

(52) U.S. Cl. 252/79.1; 216/83

(57) ABSTRACT

The present invention generally relates to an improvement in the process for etching of alumina. The novel wet etchant solution combines complexing agents with pH control to achieve improved selectivity for etching of alumina in the presence of transition metals. The novel wet etchant provides improved etching of features in alumina during fabrication of thin film magnetic structures over the non-selective conventional dry etching processes.

### CROSS-REFERENCE TO RELATED APPLICATION(S)

This application claims priority from Provisional Application No. 60/414,726 filed Sep. 30, 2002 for Highly Selective AL2O3 (alumina) Wet Etch Created for 1 TBSI Read and Write Device Structures.

### BACKGROUND OF THE INVENTION

1. Field of the Invention

The present invention generally relates to an improvement in the process for etching of alumina. More particularly this invention relates to a wet etchant solution with improved selectivity thereby allowing etching of alumina in the presence of transition metals.

2. Description of the Relevant Art

Etching is a class of common processes for the controlled removal of material. Etching of alumina is found in various applications including the fabrication of microdevices, specifically thin film magnetic structures and more specifically magnetic heads. There are various types of etching processes; however they all generally include the common actions of transport of reactants to the surface, surface reaction, and transport of products from the surface.

Several characteristics are used to describe the abilities of etching processes. The etch rate is the decrease in etch material thickness versus time. Faster etch rates are usually favored, but must be balanced with the ability to control the total amount of material removed. Uniformity of etching across a surface and between surfaces is desired. Isotropy of the etching process is also considered. The characteristics of selectivity and damage caused by the etch process often control which type of etch process is used for a particular application. Selectivity and damage will be further discussed below.

Frequently the surface is composed of more than one type of material, only one of which is desired to be etched. The material to be etched is referred to as etch material. Underlayers and surrounding material refer to the rest of the structure that is not to be etched. Selectivity is generally defined as a ratio of the etch rate of the etch material to the etch rate of the other portions of the structure that are not to be etched. Damage is often directly related to selectivity. If perfect selectivity could be achieved, only the etch material would be removed and no etching would occur to other materials. If selectivity is poor, then etching to the other materials is likely extensive, therefore described as damage. Damage may also occur by incompatibility, usually chemical in nature, between components of the etching process and materials in the structure resulting, for example, in corrosion of the structure.

Selectivity is an important consideration in etch processes because of the need for overetching to assure complete removal of the etch material. Overetching refers to the need to continue etching even though the etch process has removed etch material sufficient to expose the underlayer. Overetching is required because on a typical surface there is a pattern or topography to the surface layer due to variation in thickness of the etch material, for example due to use of a resist mask. As you etch down through the etch material layer, there will be residual material left over in thicker areas by the time the thinner areas are cleared. Etching is continued until all areas, thick and thin, are cleared of etch material. Consequently, when the etch material layer is completely removed, the surrounding materials and underlayers, which were not to be etched, may be dished out, and etching may have occurred further into the underlayer. The amount of etching that occurs into surrounding materials and underlayer, and the damage related to the etching, depends on the selectivity of the etching process. High selectivity is desired to avoid etching and/or damage of surrounding materials and underlayers.

Etching processes can be divided into two main classes: wet etching and dry etching. Wet etching is carried out in a liquid phase or liquid environment where the etch material is converted from a solid to a liquid soluble form for removal. Dry etching, by contrast, is carried out in vacuum where the material to be removed or “etch material” is converted to a gaseous form so that it will come off the surface.

Wet etching, as compared to dry etching, is generally simpler, cheaper and faster. The general process is to drop the items to be etched into a container holding the wet etchant. The main ingredients of conventional wet etchants are: an oxidizer, for example hydrogen peroxide or nitric acid; an acid or base to dissolve the oxidized surface, for example sulfuric acid or ammonium hydroxide; and a diluent media to transport reactants and products, for example water or acetic acid. When etching is complete, the items are removed and cleaned. Wet etching can be performed as a batch process, so is fast for processing larger numbers of items and reproducible. Control of wet etching is achieved by adjusting the etching time (e.g. the time in the bath) and the etching rate, which is related to the temperature and composition of the bath. Wet etching is preferred over dry etching for reasons of efficiency, but is limited in its application by poor selectivity and damage with some materials.

There are several disadvantages to conventional wet etching for the etching of alumina. The main problem is that alumina is typically to be etched on structures that also contain transition metals. Conventional wet etchants for alumina, such as: EDTA [(ethylenedinitrilo)tetraacetic acid], concentrated acids, and concentrated bases, all have poor selectivity between alumina and transition metals. Poor selectivity results in damage and corrosion to the metal portions of the structure. Metal underlayers beneath the alumina etch material are exposed and often suffer damage affecting later connections to be made at those metal underlayers. Additionally, the resist materials that are applied to the structure to control where etching occurs often fail in acid etching environments detrimentally affecting the structures. In addition, purity is a critical concern in all electronic materials processing. Highly corrosive materials, such as acids and other very reactive materials are difficult to purify.

Damage and corrosion in structures containing alumina etch material in combination with other metal features led to the development of alternatives to conventional wet etching, mainly the widespread implementation of dry etching in the fabrication of electronic microdevices with almost universal use of dry etching in the fabrication of magnetic heads for the etching of alumina.

Dry etching of alumina has proved challenging. Solid alumina or aluminum oxide is thermodynamically stable in comparison to the products produced through chemical dry etch processes. Consequently, alumina requires dry etching dominated by physical attack, e.g. a lot of ion bombardment, to basically knock the atoms apart and then etch the aluminum separately. A commonly used technique for dry etching alumina is reactive ion etching, which is a type of sputtering. In reactive ion etching, a voltage is applied to the plasma and the substrate surface. The voltage difference acts to accelerate particles out of the plasma to strike the surface with an increased energy. A combination of chemical and physical etching of the surface takes place. A variation of reactive ion etching is ion beam etching, where an ion gun provides the ions used to strike the surface.

Problems with the use of dry etching include the fact that it is both complicated and expensive. Optimization and control of the process is also very difficult because one part of the material may be etched, thereby changing the composition of species in the plasma. As the composition of the plasma changes, the rate and type of reaction at another site may be affected. In dry etching where physical removal is necessary, such as ion bombardment to remove alumina, the selectivity is poor. Surrounding structures, including resists and exposed metal layers will also tend to be etched and may be damaged. Physical dry etching processes also tend to be slow because physical removal by sputtering is not very efficient.

In addition, the end point for dry etching is not readily apparent. Undesirable surface variation in the surrounding materials and underlayer may result from the physical nature of the alumina removal. Dry etching induces additional topical variation, such as fencing; where the dry etching process redeposits the alumina etch material, thereby distorting the structure. When this technique in used to etch alumina over the back via in a writer, the dry etching redeposits alumina along the edges of the via. This creates defects that distort the magnetic flux path through the subsequently deposited top pole thereby affecting writer performance.

The selective etching of alumina is a continuing problem in fabricating microdevices. Physical removal by dry etching is the current method of choice, but is not ideal due to remaining problems caused by poor selectivity between alumina and transition metals. Therefore there is a continuing need for an efficient etch process for the removal of alumina with improved selectivity to s avoid damage to other materials in the structure, especially to prevent damage to metal layers exposed by the removal of the etch material.

### BRIEF SUMMARY OF THE INVENTION

The novel wet etchant selectively etches aluminum oxide, commonly called alumina, in the presence of transition metals with a relative rate of etching between alumina and other transition metals of at least 10 to 1. The chemistry of the novel wet etchant allows the use of wet etching in fabrication steps previously performed by conventional dry etching. The novel wet etchant comprises one or more complexing agents that form complexes with the aluminum oxide ions and further stabilize those complexes in solution. The action of the complexing agents in a defined pH range provides for selective removal of the alumina.

The complexing agents may be selected from the group consisting of: nitrilotriacetic acid, salts of nitrilotriactic acid, citric acid, and salts of citric acid. Generally, total complexing agent concentrations of less than 0.5M are sufficient. An embodiment of the novel aqueous wet etchant utilizes nitrilotriacetic acid tri-sodium salt and sodium citrate as complexing agents at a concentration ratio of approximately 1:1.

### BRIEF DESCRIPTION OF THE DRAWINGS

FIG. 1 is a graph of etch thickness by the novel wet etchant over time for various metal and alumina layers.

FIG. 2 is a cross-sectional view of a magnetic head used as an example substrate for demonstration of the novel wet etchant and associated process.

FIG. 3 is a flowchart indicating process steps using the novel wet etchant for selective removal of alumina.

FIGS. 4-7 are cross-sectional views of a partially formed writer portion of a magnetic head to demonstrate application of novel wet etchant.

FIG. 8 is a diagram showing a portion of the lead structure for a microdevice.

FIGS. 9 is a photograph of the surface of the microdevice following wet etching with the novel wet etchant.

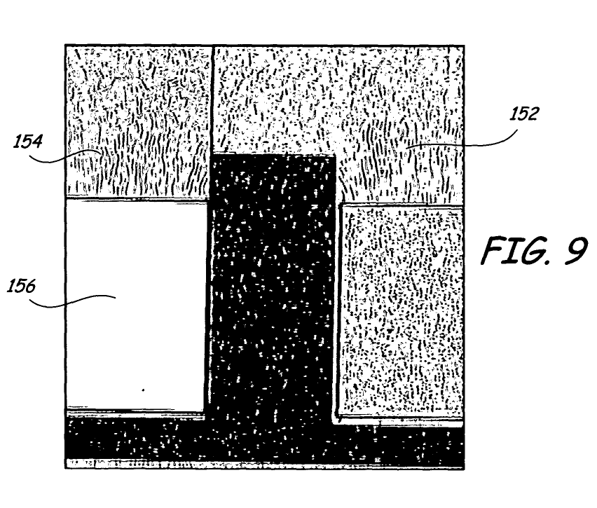

### DETAILED DESCRIPTION

The present invention generally relates to an improvement to methods of etching alumina in structures containing both alumina and metal features. More specifically, the present invention relates to a process utilizing a wet etchant to selectively remove alumina, thereby exposing underlying metal features.

Aluminum oxide (Al₂O₃), also called alumina, is the material most commonly used as an insulator in magnetic heads. Alumina is readily deposited in thin or thick layers by sputtering processes. In addition to serving as an insulator, alumina is frequently applied to protect features made from transition metals and alloys thereof within magnetic heads. Common transition metals used in the fabrication of magnetic heads include, but are not limited to: copper (Cu), gold (Au), nickel (Ni), iron (Fe), cobalt (Co), platinum (Pt), ruthenium (Ru), vanadium (V), and alloys thereof. Layers of alumina are frequently applied over the entire structure and are subsequently patterned using etching, frequently in combination with resist masks.

As discussed above, conventional etching processes for alumina do not exhibit the desired selectivity to remove alumina without also etching other materials, including transition metals. Selectivity can generally be achieved more readily with chemical etching processes rather than physical etching processes. However, conventional wet etchants or chemistries applied in dry etching processes do not demonstrate the desired selectivity for etching of alumina without also etching substrate metal layers.

This invention presents a novel wet etchant for selective removal of alumina from a substrate. The chemistry of the novel wet etchant solvates and removes alumina with minimal etching of substrate transition metal layers. The novel wet etchant does not rely on strong oxidizers and/or concentrated acids or bases as seen in conventional wet etchants. The inventive wet etchant utilizes a novel chemical combination to convert the alumina etch material into alumina ions, AlO₂⁻, and then stabilize those ions in solution. The stabilization of alumina ions in solution through the use of one or more complexing agents provides increased thermodynamic favorability to the product(s) resulting in the successful wet etching of alumina. The novel wet etchant comprises complexing agents in an aqueous solution at a pH between approximately pH 9 and pH 10.

The novel wet etchant comprises a buffered aqueous solution with a pH between approximately 9 and approximately 10, preferably between pH 9.3 and 9.7, most preferably approximately pH 9.5. The selection of pH is based upon solubility characteristics of alumina ions and the metals of interest. Transition metals and metal alloys, such as: NiFe, NiV, Au, Pt, Ru and Cu, in aqueous solution in the pH range of interest generally exhibit one of two behaviors. Either the metal is immune to corrosion (e.g. Ru) or exhibits passivity (e.g. Ni, Fe, and Cu). Passivity is where the surface is coated with a layer of metal oxide upon contact with the wet etchant. The metal oxide layer protects the metal from further reaction with the wet etchant, thereby serving as a blocking layer. Consequently, any further etching of the transition metal layer, if any, occurs only very slowly.

One or more compounds may be used to create the buffered aqueous solution. The compounds must be water-soluble and possess buffering capacity in the given pH range. Suitable compounds include, but are not limited to borate salts, such as borax (sodium tetraborate), bicarbonate salts, such as sodium bicarbonate, and hydroxide salts, such as: sodium hydroxide, potassium hydroxide, and tetramethylammonium hydroxide. The buffering compounds chosen should not be reactive with transition metals except to form stable oxide blocking layers as described above. One example of an unsuitable compound is ammonium hydroxide, which readily forms complexes with copper.

In the range of pH 9 to 10, the alumina etch material surface will be converted to AlO₂⁻ ions during solvation by the aqueous solution. The solvation of the alumina layer during wet etching is assisted by additional components of the novel wet etchant. The novel wet etchant additionally comprises one or more complexing or chelating agents. These compounds are selected for their ability to stabilize the formation of the AlO₂⁻ ions in the buffered aqueous solution and/or forming complexes with the ions and assisting the ions to solvate into solution. The chelating agents further form stable complexes in the buffered aqueous solution with the AlO₂⁻ ions. The compounds chosen for chelating agents must be water soluble in the given pH range and form complexes with alumina ions and/or stabilize alumina ion complexes. Suitable chelating agents include: nitrilotriacetic acid; salts of nitrilotriacetic acid, such as nitrilotriacetic acid tri-sodium salt (abbreviated NTANa₃); citric acid; and salts of citric acid, such as sodium citrate.

The novel wet etchant may also include one or more wetting agents. In wet etching, the items to be etched begin in air and are then placed into an aqueous environment. Bubbles may become trapped in small features thereby preventing even etching. Wetting agents prevent or decrease bubble formation. Suitable wetting agents must be stable with aqueous solutions in the pH range of interest. Examples of suitable wetting agents include: sodium laureth sulfate (SLS) and sodium dodecyl sulfate (SDS).

An embodiment of the novel wet etchant is presented below. This embodiment uses a combination of NTANa₃ and sodium citrate as complexing agents in approximately a 1:1 ratio. The ratio of complexing agents and concentration of those agents in the wet etchant may be varied. The total concentration of the complexing agents in the wet etchant will typically be less than 0.5 M. Increasing the concentration increases the rate of etching. Varying the ratio of components changes the etching capacity of the solution and rate of etching. In the embodiment, the concentration of NTANa₃ is preferably between 0 to 0.4M, most preferably approximate 0.2M and the concentration of sodium citrate is preferably between 0 and 0.4M, most preferably approximately 0.2M. An approximate concentration ratio of NTANa₃ to sodium citrate at 1:1 is preferred.

Adjusting the time of contact with the wet etchant controls the amount of etching. The rate of etching is adjusted by altering the temperature of the wet etchant bath. Increasing the temperature increases the rate of etching, decreasing the temperature, decreases the rate of etching. The embodiment of wet etchant etches alumina at a rate of approximately 12±3 nm/minute at a temperature of 48±2° C.

### EMBODIMENT

0.22 M nitrilotriacetic acid tri-sodium salt;

0.2 M sodium citrate (2-hydroxy-1,2,3,-propane-tricarboxylic acid tri-sodium salt);

0.013 M sodium tetra borate (Na₂B₄O₇);

3.5×10⁻⁴ M sodium laurel sulfate (sulfuric acid monododecyl ester sodium salt);

water; and

approximately 90 mL of 0.1 M sodium hydroxide to solution pH of 9.5±0.2;

Optional for structures containing copper layers: 0.001 M sodium thiocyanate (NaSCN).

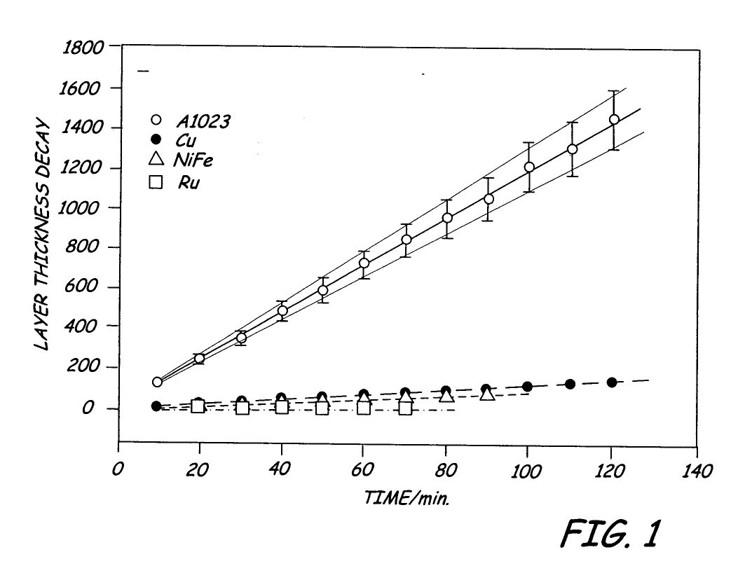

The novel wet etchant demonstrates high selectivity for etching alumina versus other sputtered or electroplated transition metals and alloys typically used in the manufacturing process for magnetic heads. Selectivity of the novel wet etchant was measured by comparing the etch rate of alumina to the etch rate of metal layers. A graph showing the decrease in layer thickness over time due to etching by the novel wet etchant is shown in FIG. 1. As shown in FIG. 1, the alumina is etched with a substantially uniform rate of approximately 12 nm/min. The Cu, NiFe and Ru samples show very little change in thickness with etching times of an hour or more at an approximate loss less than or equal to 1 nm of material thickness per minute. The selectivity of the novel wet etchant for alumina to copper is greater than 10:1; for alumina to NiFe and alumina to NiV is greater than 16:1; and for alumina to Pt, alumina to Au and alumina to Ru, the selectivity is greater than 1000:1.

The novel wet etchant exhibits a uniform etching rate across the wafer thereby increasing control of the etching process. The uniform etching and selectivity for etching of alumina allows easy determination of an ending point without jeopardizing the thickness of the metal underlayer. The endpoint is generally naturally defined by formation of a protective oxide layer on the surface of the metal underlayer. For example, for an NiFe underlayer, (Feₓ(OH)_{y}*Niₓ(OH)_{y}) is formed. The accuracy of end point determination can be increased by inclusion of small amounts of an indicator. The indicator must be soluble in the wet etchant and is preferably colorless in solution. The indicator reacts selectively with the metal in the underlayer to form a colored complex or precipitate. In the case of a Cu underlayer, the end point determination may be made more accurately by the addition of a thiocyanate indicator such as thiocyanate salts. The addition of sodium thiocyanate to the wet etchant allows end point detection with the appearance of a dark blue precipitate formed by the copper layer's reaction with the thiocyanate in solution.

One proposed application for the novel wet etchant is in fabrication of magnetic heads. The fabrication of magnetic heads involves repeated application of additive, subtractive and patterning processes of metal and dielectric materials onto a wafer. The wafer is subsequently cut into the individual heads for installation into devices such as hard disc drives. The completed magnetic head is a layered structure containing magnetically active features and electrically conductive features that are dependent on layers of insulators, such as alumina, for proper operation. The magnetically active features and electrically conductive features are commonly composed of transition metals and metal alloys including, but not limited to: Cu, Au, Pt, Ru, Co, Ni, Fe, NiFe, NiV and alloys thereof. The completion of circuits, both magnetic and electric within the structures including, magnetic heads, requires the controlled subtraction by etching of insulator, the most common being alumina.

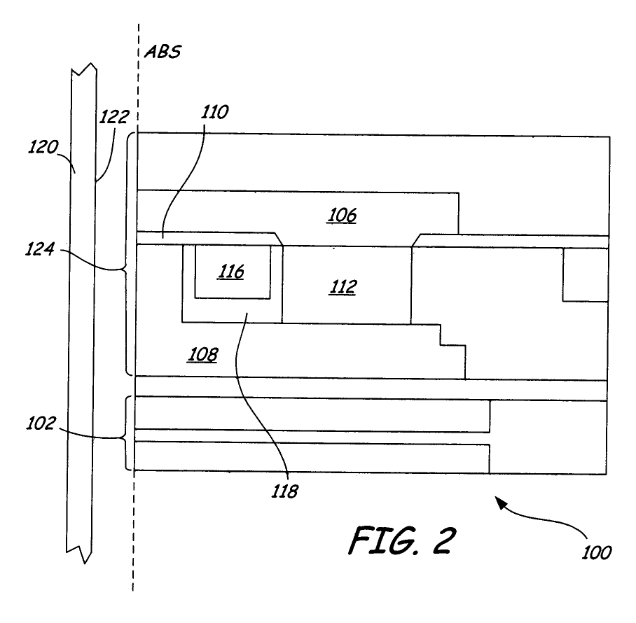

A cross-section of an example magnetic head is shown in FIG. 2. Magnetic head 100 includes both a reader portion 102 and a writer portion 104. The writer 104 consists of two magnetic poles, a top pole 106 and a bottom pole 108, separated from each other at an air bearing surface of the magnetic head 100 by a write gap 110. Additionally, the two magnetic poles are connected to each other at a region away from the air bearing surface by a back via 112. The magnetic flux path created by the top and bottom poles, 106 and 108 respectively, and back via 112, is commonly called the magnetic core 114. Positioned between the two poles are one or more layers of conductive coils 116 encapsulated by electrically insulating layers 118. To write data to the magnetic media, a time varying electrical current, or write current is caused to flow through the conductive coils 116. The write current produces a time varying magnetic field in the magnetic core. A magnetic media 120 is passed over the air bearing surface of the magnetic head 100 at a predetermined distance such that the magnetic surface 122 of the media passes through the magnetic write field. The write current is changed thereby altering the magnetic write field in intensity and direction.

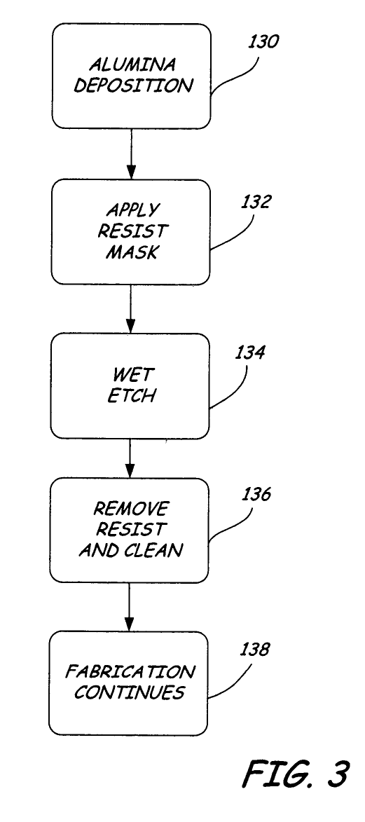

Alumina etching using the novel wet etchant is an improvement over conventional alumina etching methods used in the fabrication of magnetic heads, such as magnetic head 100. One application for the inventive wet etchant is the removal of alumina deposited in a layer to form write gap 110, thereby exposing the back via 112 in preparation for deposition of top pole 106. A flow chart outlining the relevant fabrication steps for exposing the back via and depositing the top pole is presented in FIG. 3.

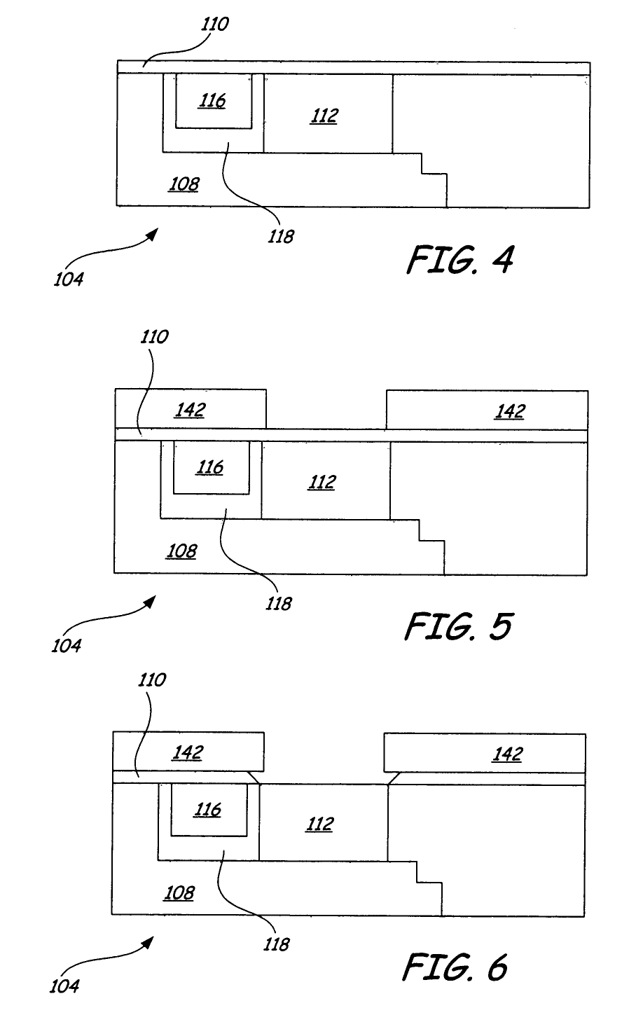

The first step 130 shown in FIG. 3 corresponds to the deposition of a layer of alumina onto a previously formed structure further described in FIG. 4-7. The novel wet etchant eliminates the need for an additional capping layer to protect the back via 112, insulator 118 and coils 116 from overetching. Next, a resist mask is applied in step 132, also shown in FIG. 5, followed by exposure to the wet etchant in step 134. The resulting structure described in FIG. 6, is removed from the wet etchant. The resist mask is removed and the structure is cleaned in step 136. The top pole is subsequently deposited in step 138, further described in FIG. 7. Fabrication continues to complete the magnetic head 100 in step 140.

The partially formed writer 104, including bottom pole 108, coils 116, insulator 118 and back via 112, is shown in FIG. 4 following deposition of a layer of alumina to form write gap 110. The write gap 110 is defined from the alumina layer by application of a resist mask 142. The resist mask 142 protects the alumina forming write gap 110, but leaves alumina exposes over back via 112. Structure 104 as shown in FIG. 5 is then exposed to wet etchant. The novel wet etchant selectively etches the exposed alumina, leaving the resist mask 142 and back via 112 intact as shown in FIG. 6. Subsequently, the resist mask is removed and the structure cleaned using deionized, double distilled, or other ultrapure water and/or other solvents to completely remove any remain traces of the resist mask and wet etchant. The resulting structure of FIG. 7 is ready for patterning and plating of a substantially planar top pole 106.

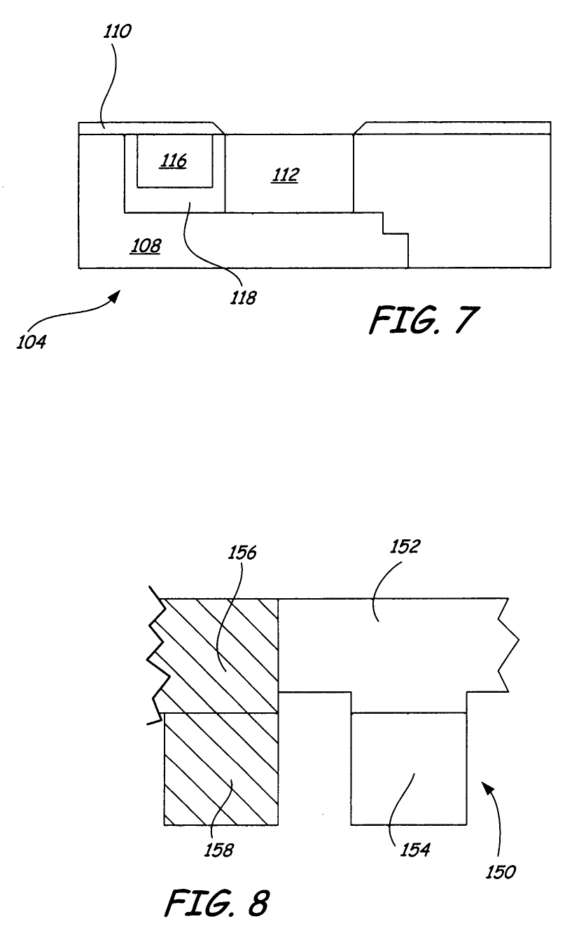

The effectiveness of the wet etchant for removal of alumina from Cu structures is demonstrated during the fabrication of a microdevice. A schematic of a portion of the lead structure 150 of the microdevice 150 is shown in FIG. 8. The device 150 consists of two layers of Cu leads, a first lead 152 including a first pad 154 and a second lead 154 including a second pad 158. The second lead is Cu coated with a thin layer of Cr, whereas the first lead is uncoated Cu.

During fabrication, the first lead 152 is deposited and subsequently surrounded by electrically insulating alumina. Then, the second lead 156 is deposited over a portion of the first lead 152, as shown in FIG. 8, but is separated from the first lead 152 by a layer of alumina (not shown). The second lead 156 is also subsequently surrounded by electrically insulating alumina. The first pad 154 and the second pad 158 are completely covered by alumina in the deposition process. Consequently etching at the probe pad locations is required in the microdevice to make proper electrical contact to probe the device, but is preferentially done in a manner so as to not damage the Cu first and second leads.

The novel wet etchant was used to etch the microdevice 150. The area to be etched was defined by application of a photoresist prior to etching. FIG. 10 is a photograph of portions of the first lead 152 including first pad 154, and second lead 156, after etching with the novel wet etchant. The second pad 158 was protected from the novel wet etchant by the photoresist. The Cu first lead 152 including the first pad 154 and the exposed portion of the second lead 156 of the Cr coated Cu are similar in appearance indicating that they were not damaged or corroded by the novel wet etchant while the alumina was completely removed. The success of the novel wet etchant demonstrates that the additional step of protecting Cu elements with Cr is not necessary. Additionally, the compatability of the novel wet etchant with photoresist was shown.

The inventive wet etchant, while presenting an improvement over conventional etching processes for selective removal of alumina in magnetic heads and other microdevices, is not limited to that purpose and may be readily extended for use in other structures requiring the selective removal of alumina in the presence of transition metals.

1. An aqueous wet etchant for selective etching of aluminum oxide in the presence of transition metals, the etchant comprising:
one or more complexing agents; and
a buffering agent for maintaining pH of the aqueous wet etchant solution within a pH range between approximately 9 and approximately 10.

2. The aqueous wet etchant of claim 1 wherein the complexing agents form complexes with aluminum oxide ions and stabilize the complexes in solution.

3. The aqueous wet etchant of claim 1 wherein the complexing agents are selected from the group consisting of: nitrilotriacetic acid, salts of nitrilotriacetic acid, citric acid, and salts of citric acid.

4. The aqueous wet etchant of claim 3 wherein the complexing agents have a total concentration of less than approximately 0.5M.

5. The aqueous wet etchant of claim 1 wherein the buffering agent is selected from the group consisting of: borate salts, hydroxide salts and bicarbonate salts.

6. The aqueous wet etchant of claim 1 wherein the complexing agents are nitrilotriacetic acid tri-sodium salt and sodium citrate.

7. The aqueous wet etchant of claim 6 wherein the Nitrilotriacetic Acid Tri-Sodium Salt and Sodium Citrate are present at a concentration ratio of approximately 1:1.

8. The aqueous wet etchant of claim 1 further comprising a wetting agent.

9. The aqueous wet etchant of claim 1 further comprising a compound that forms a colored complex with one or more transition metals.

10. An aqueous wet etchant for selective etching of alumina in the presence of transition metals, the solution comprising:
one or more complexing agents selected from the group consisting of: nitrilotriacetic acid, salts of nitrilotriacetic acid, citric acid, and salts of citric acid.

11. The aqueous wet etchant of claim 10 wherein the solution additionally comprises buffering agents to maintain the pH of the aqueous wet etchant solution within a pH range between 9 and 10.

12. The aqueous wet etchant of claim 10 wherein the buffering agents are selected from the group including: borate salts, hydroxide salts, bicarbonate salts.

13. The aqueous wet etchant of claim 10 wherein the etchant has a selectivity of at least 10:1 for alumina over transition metals.

14. The aqueous wet etchant of claim 13 wherein the transition metals are copper, nickel, iron, vanadium, gold, platinum, ruthenium or alloys thereof.

15. The aqueous wet etchant of claim 14 wherein the complexing agents are nitrilotriacetic acid tri-sodium salt and sodium citrate.

16. A method for wet etching alumina on a substrate having an alumina layer and one or more metal layers, the method comprising:
contacting the substrate with a wet etchant, the wet etchant comprising an aqueous solution of one or more complexing agents; and
removing the metal oxide layer selectively over one or more metal layers with a selectivity of at least 10 to 1.

17. The method of claim 16 wherein the complexing agents are selected from the group consisting of: nitrilotriacetic acid, salts of nitrilotriacetic acid, citric acid, and salts of citric acid.

18. The method of claim 16 wherein the wet etchant has a pH value in the range between approximately pH 9 to approximately pH 10.

19. The method of claim 16 wherein the wet etchant has a pH value between approximately pH 9 to approximately pH 10.

20. The method of claim 19 wherein the complexing agents are nitrilotriacetic acid tri-sodium salt and sodium citrate.

21. The method of claim 20 wherein the wet etchant further comprises a wetting agent.
